(19) United States
(12) Patent Application Publication
(10) Pub. No.: US 2025/0136425 A1
(43) Pub. Date: May 1, 2025

(54) Systems For Filling Fluid Receptacles

(71) Applicant: Midea Group Co., Ltd., Beijiao (CN)

(72) Inventors: Erin Leonard, Shephersdville, KY (US); Eric Scalf, Louisville, KY (US)

(21) Appl. No.: 18/498,823

(22) Filed: Oct. 31, 2023

(51) Int. Cl. B67D 1/12; B67D 1/08; F25D 23/12

(52) U.S. Cl. CPC B67D 1/12; B67D 1/0894; F25D 23/126; B67D 2001/1259

(57) ABSTRACT

A fluid receptacle filling system may include a filling head with one or more nozzles and a receptacle support shelf configured beneath the filling head. In various embodiments, the filling head and/or the receptacle support shelf may be height adjustable. In some embodiments, a valve disposed inside of the nozzles may control the flow of fluid through the nozzles into the fluid receptacles.

### BACKGROUND

The present embodiments relate to systems for filling fluid receptacles, with particular embodiments shown for height adjustable fluid receptacle filling systems and bottom filling fluid receptacle filling systems for use inside of a refrigerator.

Typical fluid receptacle filling systems may be configured to fill only a single receptacle at a time. Further, typical fluid filling systems may be configured with a fixed distance between a nozzle and a receptacle shelf, which may limit the size of fluid receptacles that the fluid filling system may fill. Further, for packaging or layout reasons, it may be advantageous to fill the fluid receptacles from beneath the fluid receptacles. Thus, there is a need for a fluid receptacle filling system that may accommodate a variety of sizes of fluid receptacles, and/or allow a fluid receptacle to be filled from underneath. A need therefore exists in the art for a height adjustable fluid receptacle filling system and/or a fluid receptacle filling system configured to fill fluid receptacles from the bottom of the fluid receptacles.

### SUMMARY

The herein-described embodiments address these and other problems associated with the art by providing systems for filling fluid receptacles that may be height adjustable and/or fill fluid receptacles from underneath the fluid receptacle. In various embodiments, the system may include a filling head having one or more nozzles. Each of the one or more nozzles may have an outlet. Each of the one or more nozzles may further have a valve, wherein when the valve is opened fluid may flow out of the nozzle and when the valve is closed fluid may not flow out of the nozzle. A receptacle support shelf may be configured beneath the filling head, and may be configured to move along a vertical axis relative to the filling head.

In addition, in some embodiments the system may include a filling head including one or more nozzles. Each of the one or more nozzles has an outlet and a valve. The valve is configured to open and close such that when the valve is opened fluid may flow through the nozzle and out of the outlet and when the valve is closed fluid may not flow through the nozzle. The system may include a receptacle support shelf. The receptacle support shelf is configured to support one or more fluid receptacles. The receptacle support shelf is configured beneath the filling head and is configured to move along a vertical axis relative to the filling head.

In some embodiments, the system may include a filling head including one or more nozzles. Each of the one or more nozzles has an outlet and a valve. The valve is configured to open and close such that when the valve is opened fluid may flow through the nozzle and out of the outlet and when the valve is closed fluid may not flow through the nozzle. The system may include a receptacle support shelf. The receptacle support shelf is configured to support one or more fluid receptacles. The receptacle support shelf is configured beneath the filling head. The filling head is configured to move along a vertical axis relative to the receptacle support shelf.

These and other advantages and features are set forth in the claims annexed hereto and forming a further part hereof. However, for a better understanding of the invention, and of the advantages and objectives attained through its use, reference should be made to the figures, and to the accompanying descriptive matter, in which there is described example embodiments of the invention. This summary is merely provided to introduce a selection of concepts that are further described below in the detailed description, and is not intended to identify key or essential features of the claimed subject matter, nor is it intended to be used in any way to the scope of the claimed subject matter.

### BRIEF DESCRIPTION OF THE DRAWINGS

FIG. 1 is a view of a fluid receptacle filling system with fluid reservoir, a filling head with a plurality of nozzles, a plurality of fluid receptacles, and a height adjustable fluid receptacle support shelf consistent with some embodiments of the fluid receptacle filling system.

FIG. 2 is an interior view of nozzle with a valve, a filling tube, a fill height sensor, and a controller, consistent with some embodiments of the fluid receptacle filling system.

FIG. 3 is a view of a fluid receptacle filling system with a fluid feed line coupled to a fluid source, a height adjustable filling head with a plurality of nozzles, a plurality of fluid receptacles, and a fluid receptacle support shelf consistent with some embodiments of the fluid receptacle filling system.

FIG. 4 is a view of a fluid receptacle support shelf with a filling head, a plurality of fluid fill seats, a plurality of fluid receptacles, and a fluid feed line consistent with some embodiments of the fluid receptacle filling system.

FIG. 5 is an exploded view of a fluid receptacle with an outer magnet and an inner magnet and a filler seat consistent with some embodiments of the fluid receptacle filling system.

### DETAILED DESCRIPTION

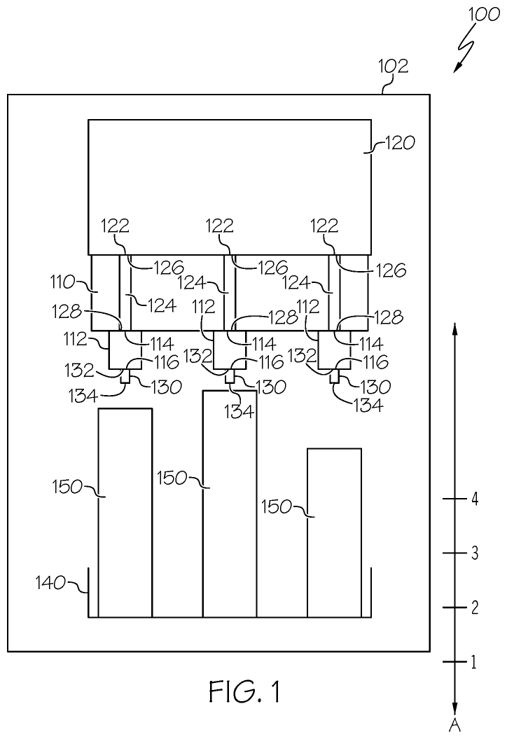

Turning now to the drawings, wherein like numbers denote like parts throughout the several views, FIG. 1 illustrates an example fluid receptacle filling system 100. The fluid receptacle filling system 100 is depicted coupled to an interior side of a refrigerator 102, however it should be understood that the fluid receptacle filling system 100 may be used in any suitable environment, including but not limited to a water cooler, a drink fountain, a water bottle filling station, or any other suitable environment.

The fluid receptacle filling system 100 includes a filling head 110. The filling head 110 includes a plurality of nozzles 112. While three nozzles 112 are illustrated, it should be understood that the fluid receptacle filling system 100 may have any suitable number of nozzles 112, including but not limited to one nozzle 112, two nozzles 112, five nozzles 112, ten nozzles 112, or any other suitable number of nozzles 112. Each of the plurality of nozzles 112 may have an inlet 114 and an outlet 116.

The fluid receptacle filling system 100 may include a fluid reservoir 120. The fluid reservoir 120 may have a plurality of outlets 122. The fluid reservoir 120 may be shaped and sized to allow a volume of fluid to reside therein. In embodiments, the fluid may be a fluid suitable for human consumption, such as water or juice, however it should be understood that any other suitable fluid may be used. The fluid reservoir 120 may be placed vertically above the filling head 110, so that fluid may flow from the fluid reservoir 120 to the filling head 110 by the force of gravity. The fluid reservoir 120 may be fillable by any suitable filling method, such as by being fluidly coupled to a fluid source such as a water pipe, by a user manually filling the fluid reservoir 120, or any other suitable filling method. In some embodiments, the fluid source may be fluidly coupled to the filling head 110, such that no fluid reservoir 120 is needed.

The fluid receptacle filling system 100 may include a plurality of fluid transfer pipes 124. Each of the fluid transfer pipes 124 may have an inlet 126 and an outlet 128. The inlet 126 of each of the fluid transfer pipes 124 may be fluidly coupled to the outlets 122 of the fluid reservoir 120. The outlet 128 of each of the fluid transfer pipes 124 may be fluidly coupled to the inlet 114 of each of the nozzles 112.

As illustrated, there may be one fluid transfer pipe 124 for each of the nozzles 112, but it should be understood that in embodiments, there may be fewer fluid transfer pipes 124, such as when the fluid transfer pipe 124 has a greater number of outlets 128 than inlets 126. As a non-limiting example, the fluid transfer pipe 124 may have one inlet 126 and three outlets 128, such that a single fluid transfer pipe 124 may be used to transfer fluid to three nozzles 112. In further embodiments, the inlet 114 of the nozzles 112 may be fluidly coupled directly to the outlets 122 of the fluid reservoir 120, such that no filling head 110 or fluid transfer pipes 124 are needed.

In some embodiments, the fluid reservoir 120, filling head 110, and/or plurality of nozzles 112 may be configured in an inner cavity of a door of the refrigerator 102. In this embodiment, the fluid reservoir 120, filling head 110, and/or plurality of nozzles 112 may be covered from view when a user utilizes the fluid receptacle filling system 100.

The fluid receptacle filling system 100 may include a plurality of filling tubes 130. The plurality of filling tubes 130 may include an inlet 132 and an outlet 134. The inlet 132 of the filling tube 130 may be fluidly coupled to the outlet 116 of the nozzle 112. In some embodiments, the filling tube 130 may be constructed of a flexible material such as rubber or silicone, such that the filling tube 130 may be flexed during operation.

The fluid receptacle filling system 100 includes a receptacle support shelf 140. The receptacle support shelf 140 may be shaped and sized so as to accommodate one or more fluid receptacles 150. The fluid receptacles 150 may be any suitable receptacle for holding fluid, including but not limited to a water bottle, a cup, a mug, or other suitable fluid receptacles. As illustrated, the receptacle support shelf 140 may accommodate three fluid receptacles 150, but it should be understood that the receptacle support shelf 140 may accommodate any number of fluid receptacles 150, including but not limited to one fluid receptacle 150, two fluid receptacles 150, five fluid receptacles 150, ten fluid receptacles 150, or any other suitable number of fluid receptacles 150. In some embodiments, fewer fluid receptacles 150 may be placed on the receptacle support shelf 140 than the receptacle support shelf 140 can accommodate, such as two fluid receptacles 150 being placed on a receptacle support shelf 140 configured to accommodate three fluid receptacles 150. The receptacle support shelf 140 may have additional features for holding the receptacles 150, such as for when the door of the refrigerator 102. As a non-limiting example, a bar or cover may be placed across the front of the receptacle support shelf 140. In other embodiments, a multi-bar linkage, with or without a spring, may be used to tension the top of the fluid receptacles 150 relative to the receptacle support shelf 140.

The receptacle support shelf 140 is height adjustable relative to the filling head 110 along axis A. Axis A may be a vertical axis. As illustrated, the receptacle support shelf 140 may be adjusted to one of a plurality of predetermined heights, labeled as points 1, 2, 3, and 4 along axis A. However, it should be understood that there may be any suitable number of predetermined heights, such as two predetermined heights, five predetermined heights, ten predetermined heights, or any other suitable number of predetermined heights. It should be understood that the receptacle support shelf 140 may also be adjusted to various heights that may not be predetermined. In other words, the receptacle support shelf 140 may be placed anywhere along the vertical axis A.

The height of the receptacle support shelf 140 may be adjusted with any suitable height adjustment mechanism. In one embodiment, the receptacle support shelf 140 may rest on one or more springs, where the receptacle support shelf may be height adjustable along axis A by tensioning or releasing tension from the springs, such as by locking a tab configured to the receptacle support shelf into a slot of the refrigerator 102 or other environments where the fluid receptacle filling system 100 may be used. In some embodiments, the one or more springs may be biased upwards towards the filling head 110, and the weight of the one or more fluid receptacles 150 may automatically adjust the height of the receptacle support shelf 140 by compressing the one or more springs. In some embodiments, the receptacle support shelf 140 may clip into the refrigerator 102 through various mounting holes placed in the refrigerator 102 along the axis A or other environments where the fluid receptacle filling system 100 may be used. In other embodiments, the receptacle support shelf 140 may use a cable and pulley system to adjust the height of the receptacle support shelf 140 along the axis A. In further embodiments, the receptacle support shelf 140 may use a ratcheting rack and pinion system to adjust the height of the receptacle support shelf 140 along the axis A. In yet further embodiments, the receptacle support shelf 140 may use a motorized track to adjust the height of the receptacle support shelf 140. In even further embodiments, the receptacle support shelf 140 may use a set of gears to adjust the height of the receptacle support shelf 140, or any other suitable height adjustment mechanism may be used to adjust the height of the receptacle support shelf 140.

By adjusting the height of the receptacle support shelf 140, a wider range of fluid receptacles 150 may be accommodated by the fluid receptacle filling system 100. That is, the receptacle support shelf may 140 be moved downwards along axis A (such as to point 1) so that a taller fluid receptacle 150 may be placed on the receptacle support shelf 140, and the receptacle support shelf may be moved upwards along axis A (such as to point 4) so that a shorter fluid receptacle 150 may be placed on the receptacle support shelf 140. While a shorter fluid receptacle 150 may be placed on the receptacle support shelf 140 while the receptacle support shelf 140 is at point 1, by adjusting the height of the receptacle support shelf 140 there may be a reduced likelihood of misalignment and/or spillage between the outlet 134 of the filling tube 130 and the fluid receptacle 150.

In embodiments, there may be a plurality of receptacle support shelfs 140 arranged. Each of the plurality of receptacle support shelfs 140 may be independently height adjustable. As a non-limiting example. A first receptacle support shelf 140 may be adjusted to point 1 on axis A, a second receptacle support shelf 140 may be adjusted to point 2 on axis A, and a third receptacle support shelf 140 may be adjusted to point 3 on axis A. By allowing each of the plurality of receptacle support shelfs 140 to be independently height adjustable, a variety of sizes of fluid receptacles 150 may be filled by the fluid receptacle filling system 100.

In embodiments, the filling head 110, the fluid transfer pipe 124, the filling tubes 130, and/or the nozzles 112 may be constructed of, for example, food grade silicone or silver ion microbial plastic to prevent microbial growth. The filling tubes 130, the nozzles 112, and/or the fluid transfer pipe 124 may be removable for ease of disassembly for servicing and/or cleaning.

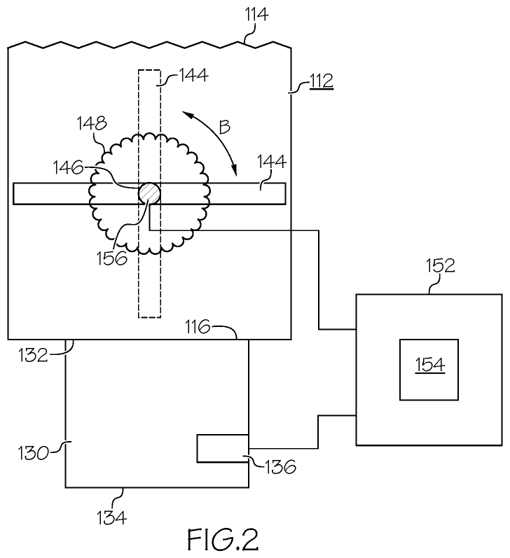

FIG. 2 illustrates an interior view of a nozzle 112 and a filling tube 130. A valve 144 may be disposed inside of the nozzle 112. The valve 144 may be configured to open and close in order to allow or not allow the flow of fluid through the nozzle 112. That is, when the valve 144 is fully or partially open, fluid may flow through the nozzle 112, and when the valve 144 is closed, fluid may not flow through the nozzle 112. The valve 144 is shown as solid in the closed position and in phantom in the fully open position.

In the illustrated embodiment, the valve 144 is a butterfly valve. The valve 144 may include a pivot 146 around which the valve 144 may rotate along arc B. In other embodiments, any other suitable type of valve may be used, including but not limited to a globe valve, a gate valve, a ball valve, a plug valve, or any other suitable type of valve.

A mechanical closing mechanism 148 may be coupled to the valve 144. The mechanical closing mechanism 148 may be configured to allow a user to change the open or close state of the valve, thereby controlling the flow of fluid through the nozzle 112. The mechanical closing mechanism 148 may be a rotary knob, a lever, or any other suitable mechanism. As illustrated, the mechanical closing mechanism 148 is attached directly to the valve 144, but it should be understood that, in embodiments, the mechanical closing mechanism 148 may be coupled to the valve 144 via a cable and pulley, a multi-bar linkage, a chain and gear, or any other suitable coupling mechanism.

A fill height sensor 136 may be disposed within the filling tube 130. The fill height sensor 136 may be configured to detect the fill level inside of the fluid receptacles 150. The fill height sensor 136 may be any suitable type of fill height sensor for determining a fill level inside of the fluid receptacles 150, including but not limited to a pressure sensor, a light sensor, or any other suitable type of fill height sensor.

In other embodiments not shown, the filling tube 130 may be inserted into the one or more fluid receptacles 150. In this embodiment, a bobber or proximity type sensor may be used for the fill height sensor 136, although any other suitable type of fill height sensor 136 may be used.

The fill height sensor 136 may be communicatively coupled to a controller 152. The controller 152 may include a processor and a non-transitory, processor-readable storage medium for storing program modules that, when executed by a processor, perform one or more processes described herein. The non-transitory, processor-readable storage medium may be one or more memory devices that store data as well as software and may also comprise, for example, one or more of RAM, ROM, magnetic storage, or optical storage. The controller 152 may be communicatively coupled to a motor 156. The motor 156 may be any suitable motor, including but not limited to a stepper motor, a servo motor, or any other suitable type of motor. The motor 156 may be configured to the valve 144 in order to open and close the valve 144. That is, the fill height sensor 136 may communicate a signal to the controller 152 when the fill height sensor 136 determines the fluid fill level in the fluid receptacle 150 has reached a predetermined fill level. The controller 152 may then communicate a signal to the motor 156 to close the valve 144. In various other embodiments where different types of valves than a butterfly valve is used, other suitable electromechanical devices may be communicatively coupled to the controller 152 and used to open and close the valve 144, such as a pneumatic or hydraulic ram, or any other suitable device.

An electronic activation device 154 may be communicatively coupled to the controller 152. The electronic activation device 154 may be, for example, a button, a switch, a touchpad, or any other suitable type of electronic activation device. A user may activate the electronic activation device 154 to change the open or close state of the valve 144. That is, when activated the electronic activation device 154 may communicate a signal to the controller 152. The controller 152 may then communicate a signal to the motor 156 to change the open or close state of the valve 144. In embodiments, the signal may correspond to opening the valve 144 for a predetermined amount of time, such as one second, three seconds, five seconds, or any other amount of time. In other embodiments, the signal may last for as long as the electronic activation device 154 is activated, such as keeping the valve 144 open for as long as the button is depressed. In further embodiments, a first activation of the electronic activation device 154 may change the open or close state of the valve 144 until another activation of the electronic activation device 154 occurs, such as the valve 144 opening for a first activation of the electronic activation device 154 and closing for a second activation of the electronic activation device 154.

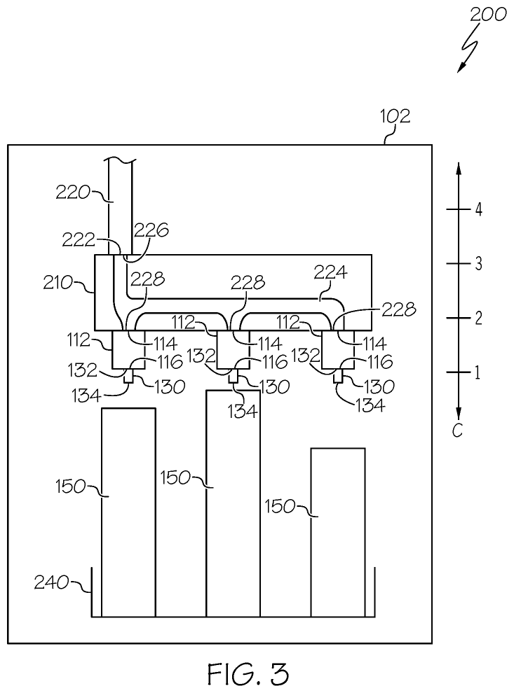

FIG. 3 illustrates an alternative embodiment of an example fluid receptacle filling system 200. The fluid receptacle filling system 200 may be configured in similar environments as the fluid receptacle filling system 100, such as to an interior side of a refrigerator 102, a water cooler, a drink fountain, a water bottle filling station, or any other suitable environment.

The fluid receptacle filling system 200 includes a filling head 210. The filling head 210 may have a fluid transfer pipe 224 disposed therein. The fluid transfer pipe 224 may have an inlet 226 and a plurality of outlets 228. Each of the plurality of outlets 228 of the fluid transfer pipe 224 may be coupled to the inlet 114 of one of the nozzles 112. The inlet 226 of the fluid transfer pipe 224 may be coupled to a fluid feed line 220 at an inlet 222 of the fluid feed line 220. The fluid feed line 220 may be fluidly coupled to a fluid source, such as a water pipe or water tank. The fluid feed line 220 may be made of an expandable material, such as rubber or corrugated material, or can be configured to be extendible in a given direction, so that the fluid feed line 220 may extend and contract as the filling head 210 moves vertically, as will be described in more detail herein. As a non-limiting example, the fluid feed line 220 may be arranged in a series of coil loops so that the fluid feed line 220 may extend and contract as the filling head 210 moves vertically.

The fluid receptacle filling system 200 includes a receptacle support shelf 240. The receptacle support shelf 240 may be shaped and sized similar to the receptacle support shelf 140 shown and described in FIG. 1, however the receptacle support shelf 240 may be fixed in place vertically along axis C.

The filling head 210 is height adjustable relative to the receptacle support shelf 240 along axis C. Axis C may be a vertical axis. As illustrated, the filling head 210 may be adjusted to one of a plurality of predetermined heights, labeled as points 1, 2, 3, and 4 along axis C. However, it should be understood that there may be any suitable number of predetermined heights, such as two predetermined heights, five predetermined heights, ten predetermined heights, or any other suitable number of predetermined heights. It should be understood that the filling head 210 may also be adjusted to various heights that may not be predetermined. In other words, the filling head 210 may be placed anywhere along the vertical axis C.

The filling head 210 may be height adjustable with any suitable height adjustment mechanism. In one embodiment, the filling head 210 may rest on one or more springs, where the receptacle support shelf 240 may be height adjustable along axis C by tensioning or releasing tension from the springs, such as by locking a tab configured to the receptacle support shelf 240 into a slot of the refrigerator 102 or other environments where the fluid receptacle filling system 200 may be used. In some embodiments, the filling head 210 may clip into the refrigerator 102 through various mounting holes placed in the refrigerator 102 along the axis C, or other environments where the fluid receptacle filling system 200 may be used. In other embodiments, the filling head 210 may use a cable and pulley system to adjust the height of the filling head 210 along the axis C. In further embodiments, the filling head 210 may use a ratcheting rack and pinion system to adjust the height of the filling head 210 along the axis C. In yet further embodiments, the filling head 210 may use a motorized track to adjust the height of the filling head 210. In even further embodiments, the filling head 210 may use a set of gears to adjust the height of the filling head 210, or any other suitable height adjustment mechanism may be used to adjust the height of the filling head 210.

In further embodiments, it is contemplated that both the filling head 110 and the receptacle support shelf 140 of the fluid receptacle filling system 100 and/or both the filling head 210 and the receptacle support shelf 240 of the fluid receptacle filling system 200 may be independently height adjustable. By allowing both the filling head and the receptacle support shelf to be height adjustable, an increased size range of fluid receptacles 150 may be accommodated by the fluid receptacle filling systems compared to fluid receptacle filling systems with only one height adjustable component.

In embodiments, the filling head 210 may be constructed of food grade silicone or silver ion microbial plastic to prevent microbial growth.

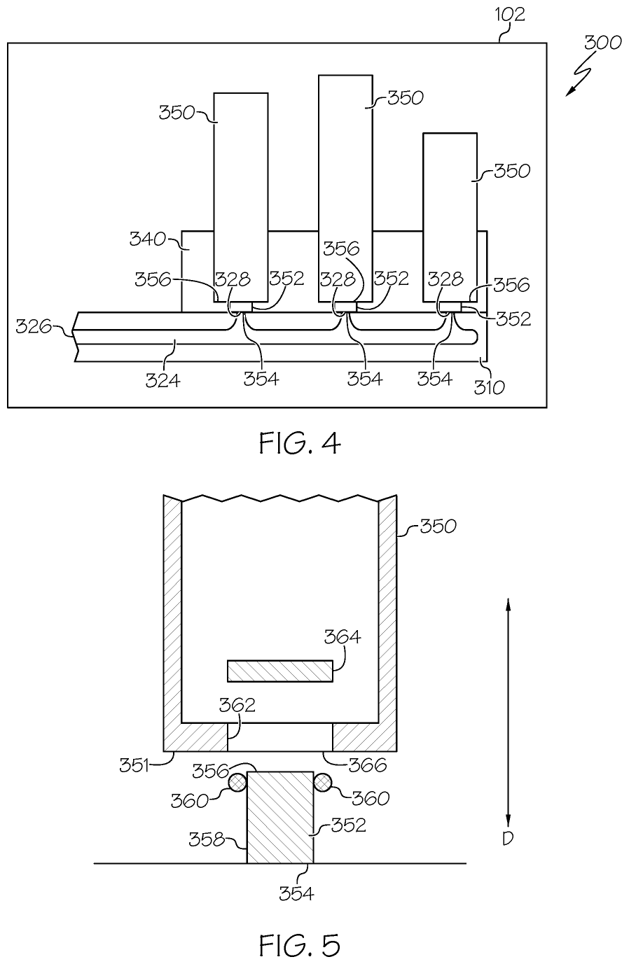

FIG. 4 illustrates an alternative embodiment of an example fluid receptacle filling system 300. The fluid receptacle filling system 300 may be configured in similar environments as the fluid receptacle filling system 100 and the fluid receptacle filling system 200, such as to an interior side of a refrigerator 102, a water cooler, a drink fountain, a water bottle filling station, or any other suitable environment.

The fluid receptacle filling system 300 includes a receptacle support shelf 340. The receptacle support shelf 340 may shaped and sized so as to accommodate one or more fluid receptacles 350. The fluid receptacles 350 may be configured for use with the fluid receptacle filling system 300, as will be described in more detail herein. As illustrated, the receptacle support shelf 340 may accommodate three fluid receptacles 350, but it should be understood that the receptacle support shelf 340 may accommodate any number of fluid receptacles 350, including but not limited to one fluid receptacle 350, two fluid receptacles 350, five fluid receptacles 350, ten fluid receptacles 350, or any other suitable number of fluid receptacles 350. In some embodiments, fewer fluid receptacles 350 may be placed on the receptacle support shelf 340 than the receptacle support shelf 340 can accommodate, such as two fluid receptacles 350 being placed on a receptacle support shelf 340 configured to accommodate three fluid receptacles 350.

The fluid receptacle filling system 300 includes one or more filling seats 352. The one or more filling seats 352 may be shaped and sized to secure the fluid receptacle 350 to the receptacle support shelf 340. The one or more filling seats 352 may have an inlet 354 and an outlet 356. The one or more filling seats 352 may have an outer surface 358. The one or more filling seats 352 may have a gasket 360 placed around outer surface 358. The gasket 360 may be made of a compliant material to provide a seal between the filling seat 352 and the fluid receptacle 350, such as rubber or silicone.

The fluid receptacle filling system 300 may include a filling head 310. The filling head 310 may have a fluid transfer pipe 324 disposed therein. The fluid transfer pipe 324 may have an inlet 326 and a plurality of outlets 328. Each of the plurality of outlets 328 of the fluid transfer pipe 324 may be coupled to the inlet 354 of one of the filling seats 352. The inlet 326 of the fluid transfer pipe 324 may be fluidly coupled to a fluid source, such as a water pipe or tank.

By placing the filling head 310 below the receptacle support shelf 340, the fluid receptacle filling system 300 may have a more compact size than the fluid receptacle filling systems 100 or 200.

In embodiments, the filling head 310, the fluid transfer pipe 324, and/or the filling seats 352 may be constructed of food grade silicone or silver ion microbial plastic to prevent microbial growth. The filling seats 352 and/or the fluid transfer pipe 324 may be removable for ease of disassembly for servicing and/or cleaning.

FIG. 5 illustrates an exploded section view of the fluid receptacle 350 and the filling seat 352 according to one or more embodiments shown and described herein, exploded along an axis D. The fluid receptacle 350 may include an outer magnet 362 and an inner magnet 364. The outer magnet 362 may be integrated with a bottom surface 351 of the one or more of the fluid receptacles 350. The outer magnet 362 may be arranged to fit around the filling seat 352, such that the filling seat 352 may fit inside of and seal against the outer magnet 362. The inner magnet 364 may be shaped and sized to fit inside of the outer magnet 362. When the fluid receptacle 350 is not interacting with the filling seat 352, the magnetic attraction between the outer magnet 362 and the inner magnet 364 may seal the bottom surface 351 of the one or more fluid receptacles 350.

The filling seat 352 may displace the inner magnet 364 when the fluid receptacle 350 is placed on the receptacle support shelf 340. This may allow fluid to enter the fluid receptacle 350 through the inlet 366 of the fluid receptacle 350.

In embodiments, the outer magnet 362 may be a series of one or more individual magnets arranged axially around the inlet 366 of the fluid receptacle 350.

The one or more filling seats 352 may have an outer surface 358. The one or more filling seats 352 may have a gasket 360 placed around outer surface 358. The gasket 360 may be made of a compliant material to provide a seal between the filling seat 352 and the fluid receptacle 350, such as rubber or silicone.

As illustrated, the filling seat 352, the outer magnet 362, and the inner magnet 364 may have a circular cross-sectional shape. In some embodiments, the outer magnet 362 and the inner magnet 364 may be other suitable shapes, such as a rectangular cross-section, an oval cross-section, or any other suitable shape.

Numerous variations and modifications to the fluid receptacle filling systems 100, 200, and 300 illustrated in FIGS. 1-5 will be apparent to one of ordinary skill in the art, as apparent from the description above. Therefore, the invention is not limited to the specific implementations discussed herein.

While several embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, embodiments may be practiced otherwise than as specifically described and claimed. Embodiments of the present disclosure are directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one. B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

It is to be understood that the embodiments are not limited in its application to the details of construction and the arrangement of components set forth in the description or illustrated in the drawings. The invention is capable of other embodiments and of being practiced or of being carried out in various ways. Unless limited otherwise, the terms “connected,” “coupled,” “in communication with,” and “mounted,” and variations thereof herein are used broadly and encompass direct and indirect connections, couplings, and mountings. In addition, the terms “connected” and “coupled” and variations thereof are not restricted to physical or mechanical connections or couplings.

The foregoing description of several embodiments of the invention has been presented for purposes of illustration. It is not intended to be exhaustive or to limit the invention to the precise steps and/or forms disclosed, and obviously many modifications and variations are possible in light of the above teaching.

1. A system for filling a fluid receptacle with a fluid, the system comprising:
a filling head, the filling head comprising one or more nozzles, each of the one or more nozzles having:
an outlet; and
a valve, the valve configured to open and close such that when the valve is opened fluid may flow through the nozzle and out of the outlet and when the valve is closed fluid may not flow through the nozzle; and
a receptacle support shelf, the receptacle support shelf configured to support one or more fluid receptacles, wherein the receptacle support shelf is configured beneath the filling head and is configured to move along a vertical axis relative to the filling head.

2. The system of claim 1, wherein the system is configured for use inside of a refrigerator.

3. The system of claim 1, wherein the one or more nozzles are fluidly coupled to a fluid source.

4. The system of claim 3, further comprising:
a filling tube fluidly coupled to the nozzle, the filling tube having an inlet and an outlet; and
a fill height sensor, the fill height sensor disposed within the filling tube and communicatively coupled to the valve, wherein the fill height sensor is configured to communicate a signal to the valve to close the valve if the if the fill height sensor determines a fluid height inside of the fluid receptacle has reached a predetermined fill height.

5. The system of claim 4, wherein the fill height sensor comprises a pressure sensor.

6. The system of claim 3, further comprising:
an electronic activation device communicatively coupled to the valve, the electronic activation device configured to, when activated, communicate a signal to change the open or close state of the valve.

7. The system of claim 3, further comprising:
the valve having a mechanical closing mechanism, the mechanical closing mechanism configured to be operated by a user to open and close the valve.

8. The system of claim 3, wherein the fluid source comprises a fluid reservoir, the fluid reservoir configured vertically above the one or more nozzles.

9. The system of claim 1, wherein the receptacle support shelf is rested upon one or more springs, the one or more springs configured to adjust a height of the receptacle support shelf relative to the nozzles.

10. The system of claim 1, wherein the receptacle support shelf is configured to be adjusted to one or more predetermined positions along the vertical axis.

11. A system for filling a fluid receptacle with a fluid, the system comprising:
a filling head, the filling head comprising one or more nozzles, each of the one or more nozzles having:
an outlet; and
a valve, the valve configured to open and close such that when the valve is opened fluid may flow through the nozzle and out of the outlet and when the valve is closed fluid may not flow through the nozzle; and
a receptacle support shelf, the receptacle support shelf configured to support one or more fluid receptacles, wherein the receptacle support shelf is configured beneath the filling head, and wherein the filling head is configured to move along a vertical axis relative to the receptacle support shelf.

12. The system of claim 11, wherein the system is configured for use inside of a refrigerator.

13. The system of claim 11, wherein the one or more nozzles are fluidly coupled to a fluid source.

14. The system of claim 13, further comprising:
a filling tube fluidly coupled to the nozzle, the filling tube having an inlet and an outlet; and
a fill height sensor, the fill height sensor disposed within the filling tube and communicatively coupled to the valve, wherein the fill height sensor is configured to communicate a signal to the valve to close the valve if the if the fill height sensor determines a fluid height inside of the fluid receptacle has reached a predetermined fill height.

15. The system of claim 14, wherein the fill height sensor comprises a pressure sensor.

16. The system of claim 13, further comprising:
an electronic activation device communicatively coupled to the valve, the electronic activation device configured to, when activated, communicate a signal to change the open or close state of the valve.

17. The system of claim 13, further comprising:
the valve having a mechanical closing mechanism, the mechanical closing mechanism configured to be operated by a user to open and close the valve.

18. The system of claim 13, wherein the fluid source comprises a fluid reservoir, the fluid reservoir configured vertically above the one or more nozzles.

19. The system of claim 11, wherein the filling head is rested upon one or more springs, the one or more springs configured to adjust a height of the filling head relative to the receptacle support shelf.

20. The system of claim 11, wherein the filling head is configured to be adjusted to one or more predetermined positions along the vertical axis.
